(19) United States
(12) Patent Application Publication
(10) Pub. No.: US 2021/0036528 A1
(43) Pub. Date: Feb. 4, 2021

(54) PORTABLE POWER BOTTLE

(71) Applicant: Advanced Wireless Innovations, LLC, Santa Monica, CA (US)

(72) Inventor: Gerard Casale, Santa Monica, CA (US)

(21) Appl. No.: 16/943,362

(22) Filed: Jul. 30, 2020

Related U.S. Application Data
(60) Provisional application No. 62/880,434, filed on Jul. 30, 2019.

(51) Int. Cl. H02J 7/00; H02J 7/34; A47J 41/02

(52) U.S. Cl. CPC H02J 7/0045; A47J 41/02; H02J 7/0048; H02J 7/342

(57) ABSTRACT

Provided herein is a portable power bottle for recharging electronic devices, including body having an opening at a proximal end, the body forming a vessel in communication with the opening, the vessel for containing the fluid to be provided to the user via the opening. The bottle further includes a cap that is removably attached to the body proximate the opening to alternatively open and seal the opening, and a battery assembly attached to the body at a distal end opposite the proximal end of the body. The battery assembly comprising a battery and one or more charging ports, the battery for storing the electric charge to be provided to the electronic device via the one or more charging ports.

### CROSS-REFERENCES TO RELATED APPLICATIONS

The present application claims the benefit of U.S. Provisional Application No. 62/880,434 filed Jul. 30, 2019, and entitled “PORTABLE POWER BOTTLE”, the entire contents of which are incorporated herein by reference.

### BACKGROUND OF THE INVENTION

Portable charging systems to recharge electronic devices such as cellular phones or other small personal electronics are often large and heavy, and may be inconvenient to use or travel with. Even portable power banks of a smaller size constitute an extra accessory that must be carried with a user to recharge their personal electronic device(s). Accordingly, what is needed is a portable charging system that is integrated into existing accessories or items, to simplify the process of recharging electronic devices.

### BRIEF SUMMARY OF THE INVENTION

Provided herein is an apparatus configured to provide a fluid to a user and an electric charge to an electronic device. The apparatus includes a body having an opening at a proximal end, the body forming a vessel in communication with the opening, the vessel configured for containing the fluid to be provided to the user via the opening; a cap that is removably attached to the body proximate the opening, to alternatively open and seal the opening; and a battery assembly attached to the body at a distal end opposite the proximal end of the body, the battery assembly including a battery and one or more charging ports and the battery for storing the electric charge to be provided to the electronic device via the one or more charging ports.

In embodiments, the body is a double-walled body with an insulating seal. In embodiments, the insulating seal is a vacuum seal.

In embodiments, the cap can be attached by corresponding thread members on each of the cap and the body. In embodiments, the cap can be attached by a friction fit between the cap and the opening.

In embodiments, at least one of the charging ports is a Universal Serial Bus (USB) port. In embodiments, the battery assembly is removably attached to the body by threaded connectors. In embodiments, the battery assembly includes a power indicator. In embodiments, the power indicator includes one or more LEDs.

In embodiments, the apparatus further includes one or more battery life indicators to indicate a battery life of the battery. In embodiments, the one or more battery life indicators are Light Emitting Diodes (LEDs).

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1A is a front perspective view of a portable power bottle.

FIG. 1B is a rear perspective view of a portable power bottle.

FIG. 2A is a front plan view of a portable power bottle.

FIG. 2B is an exploded front plan view of a portable power bottle.

FIG. 3 is an exploded front perspective view of the battery assembly and components.

FIG. 4 is a front perspective view of several optional embodiments of a portable power bottle.

FIGS. 5A and 5B show a charger for attachment to a fluid container.

Like reference symbols in the various drawings indicate like elements.

### DETAILED DESCRIPTION OF THE INVENTION

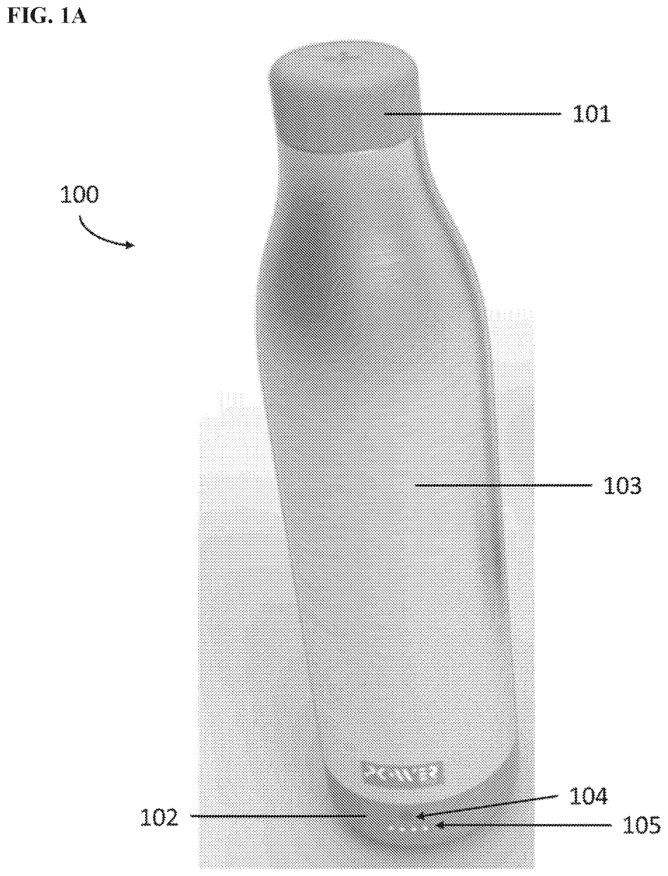

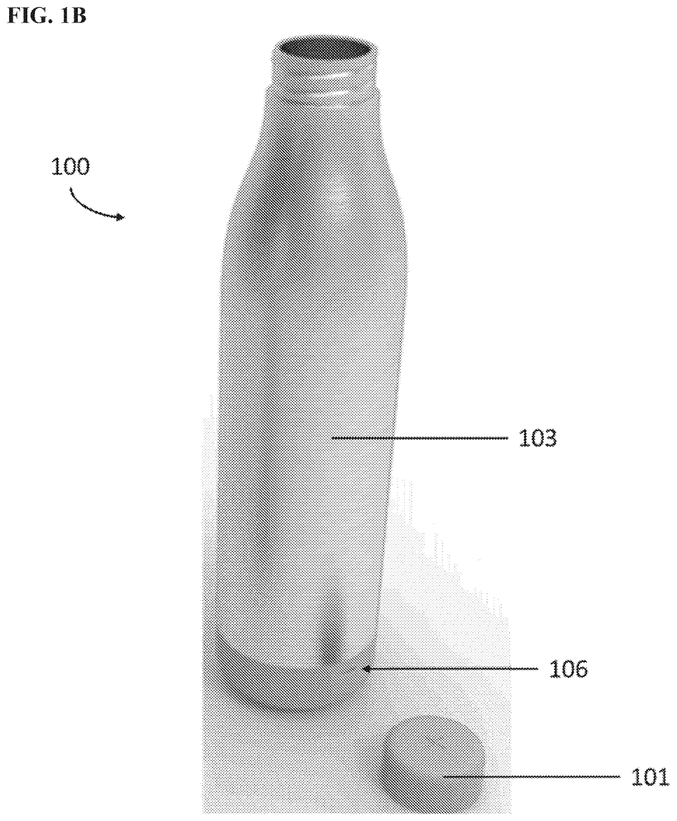

As shown in FIGS. 1A and 1B, a portable power bottle 100 may be configured to include a cap 101, a body 103, a battery assembly 102, and at least one charging port 106. In some example embodiments, the body 103 may include at least one cavity configured to hold a substance including, for example, a fluid and/or the like. The battery assembly 102 may be detachably coupled with the body 103. Furthermore, the battery assembly 102 may include one or more light emitting diode (LED) indicator lights, such as, for example, an LED power indicator 104, one or more LED battery life indicators 105, and/or the like.

In some embodiments, the LED power indicator 104 may indicate the power state of the battery assembly 102. For example, the LED may be illuminated when power is flowing to the battery assembly 102 and not illuminated when power is not flowing to the battery assembly 102. Additionally or alternatively, the LED power indicator 104 may indicate the charging state. For example, the LED may be illuminated using different colors or different levels of brightness to indicate that the battery assembly 102 is not ready to charge, ready to charge, or currently charging. In some embodiments, the one or more LED battery life indicators 105 include multiple LEDs which can be illuminated in varying numbers, patterns, or colors to indicate the battery life, or charge remaining in the battery assembly 102. For example, the number of illuminated LED battery life indicators 105 may be increased to indicate more charge remaining in the battery assembly 102 and decreased to indicate less remaining charge remaining in the battery assembly 102. Additionally or alternatively, the LED battery life indicators 105 may be illuminated separately and/or at different time intervals, to create a light pattern which provides information regarding the charge remaining in the battery assembly 102. In one example, the LED battery life indicators 105 may flash on and off together and/or separately at a slower speed to indicated more charge remaining in the battery assembly 102 and at a higher speed to indicate less charge remaining in the battery assembly 102. Additionally or alternatively, the LED battery life indicators 105 may indicate a volume or amount, or a temperature, of substance remaining in the body 103. For example, the LED battery life indicators 105 may be illuminated in various colors or combinations to indicate the temperature or volume of the substance contained in the body 103, or the number of LED battery life indicators 105 may be increased to indicate higher temperature or volume and decreased to indicate lower temperature or volume. In some embodiments, the LED battery life indicators may be configured to be reversibly switched between indicating the life of the battery assembly 102, indicating the volume or amount of substance remaining in the body 103, and indicating the temperature of the substance contained in the body 103.

The cap 101 may be made of any suitable material, including without limitation: plastics, polymers, metals, alloys, or the like. The body 103 may be made of any suitable material, including without limitation: plastics, polymers, metals, alloys, or the like. Additionally or alternatively, the body 103 may be configured to include a double wall system wherein the walls of the body 103 are vacuum layered or hermetically sealed to preserve the temperature of the substance being contained. The removable battery assembly 102 may include one or more charging ports 106, and the ports may be configured to receive the same or different electronic chargers. The charging ports 106 may be USB, USB-A, USB-C, mini-USB, micro-USB, 8-pin, 30-pin, or any other port configuration. The charging ports 106 may be charge/discharge charging ports.

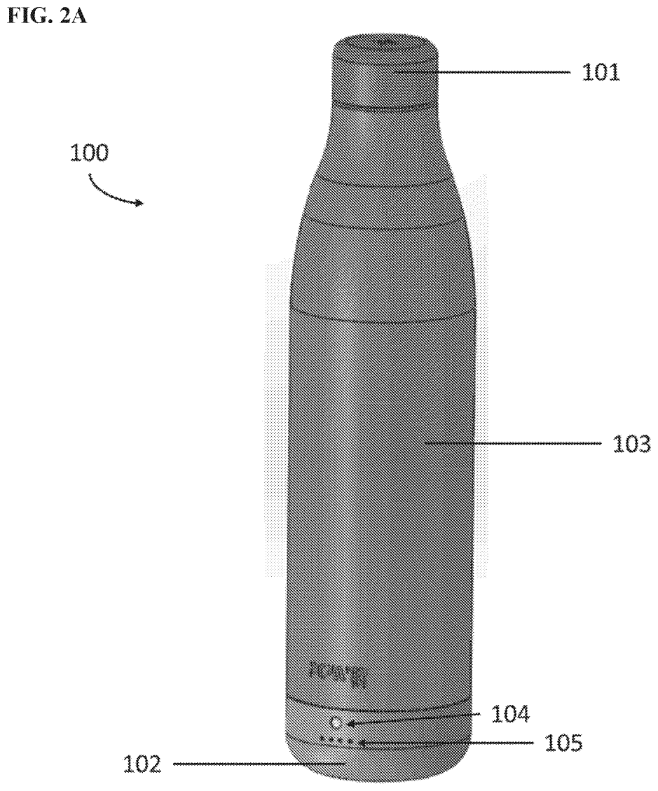

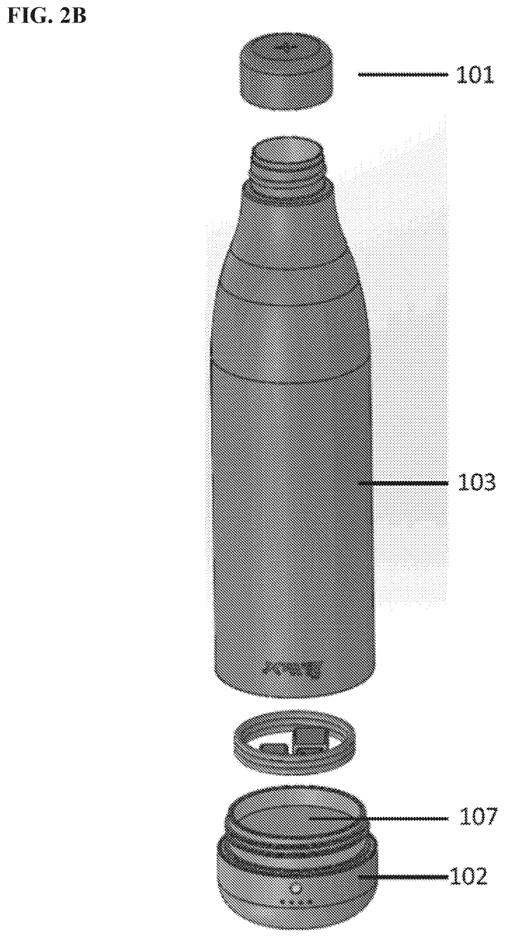

As shown in FIGS. 2A and 2B, the portable power bottle 100 may be separated into individual components including the cap 101, body 103, and battery assembly 102 which may include a cavity 107 for cable storage.

The body 103 may be any shape suitable to contain a fluid, including without limitation, an elongated shape, a truncated shape, a compressed shape, a symmetrical shape, an asymmetrical shape, etc. The body 103 may be fabricated from any material suitable to contain a fluid, such as a polymer, a metal, an alloy, a composite, glass, ceramic, etc. The body 103 may further include a second wall, i.e. the body 103 may be a double-walled body. The double-walled body may provide an insulating seal. The insulating seal may be created in any matter suitable for manufacturing, such as a vacuum seal, a gas placed between the outer wall and the inner wall, or any other insulating material placed between the outer wall and the inner wall. The battery assembly 102 and/or the cap 101 may have the same cross-sectional dimensions as the body 103, such that the battery and/or the cap 101 may sit flush with the body 103 and create an almost seamless profile. The opening at the proximal end of the body 103 may be of any aperture suitable to provide fluid to the user via the opening. Accordingly, the cap 101 may be of any size to fit the aperture of the opening at the proximal end of the body 103. For example, the cap may have a small size in order to fit over and seal a small aperture such as that of a drinking bottle. Alternatively, the cap may have a larger size in order to fit over and seal a larger aperture, and may further be configured to function as a separate bowl-like receptacle.

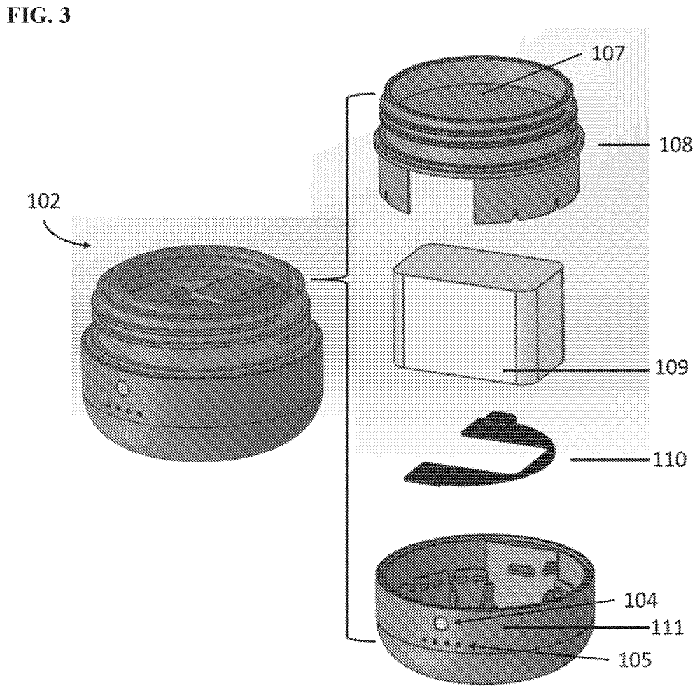

As shown in FIG. 3, the battery assembly 102 may be manufactured as an assembly of several components such as an upper housing 108 including a cavity 107 for cable storage, a battery power bank 109, a printed circuit board (PCB) 110, and a bottom housing 111 which includes the LED power indicator 104 and the one or more LED battery life indicators 105. The LED power indicator 104 may light up to indicate that the charging port 106 is in use. One or more of the one or more LED battery life indicators 105 may light up to indicate the remaining battery life in the battery power bank 109. The battery power bank 109 may be any suitable size or capacity.

The battery power bank 109 may be bidirectional. In some embodiments, the battery power bank 109 may be bidirectional such that the battery is capable of charging an internal component, such as a heating element for the purpose of heating a substance contained in the body 103 or a cooling system for the purpose of cooling a substance contained in the body 103, or being redirected to recharge an external electronic device. The portable power bottle 100 may be configured to include more than one battery assembly 102, each having their own housing 108, cavity 107, battery power bank 109, and PCB 110. The multiple battery assemblies 102 may be stacked. Additionally or alternatively, the multiple battery assemblies 102 may each be configured to charge the same or different objects such as various external electronic devices or the substance contained in the body 103.

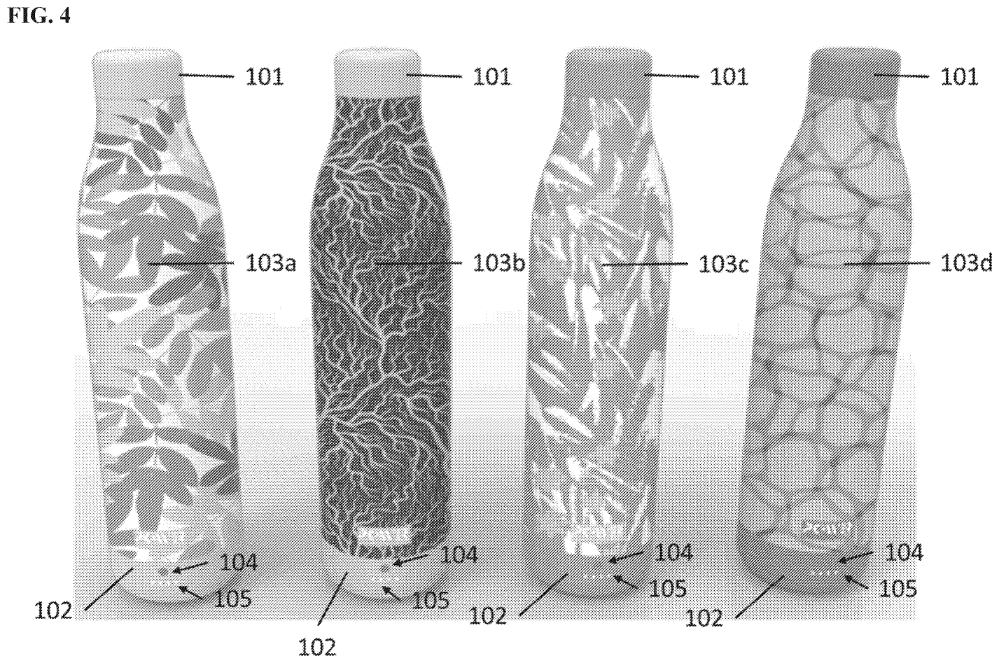

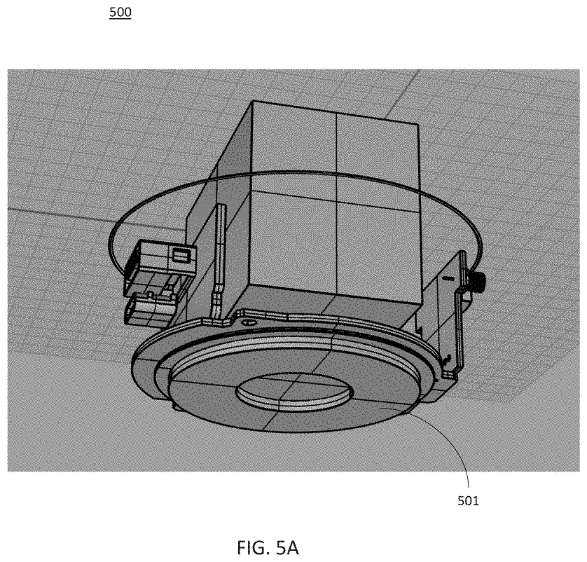

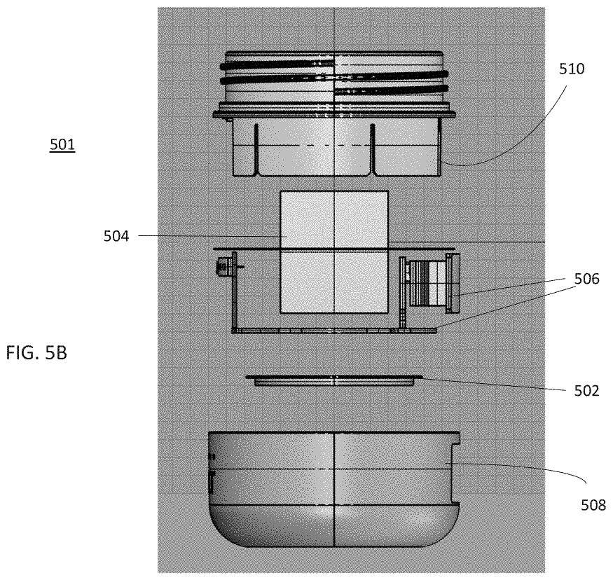

FIG. 4 illustrates various optional embodiments for the body 103a, 103b, 103c, and 103d. Further, in some implementations consistent with the disclosure herein, and as shown in FIGS. 5A and 5B, a fluid container 500 includes bi-directional wireless charger 501, which can be implemented as a screw-on or otherwise attachment to a fluid containing section of the fluid container 500. The charger 501 uses a single coil 502 to both transfer power and receive power to and from battery cells 504. This allows the user to use the power bottle to 1) wireless charge a device by putting the devices on the bottom of the bottle where the coil resides and 2) wirelessly charge the power bottle by placing the bottle on any Qi wireless charger. The charger 501 of the fluid container 500 can include a top enclosure 510, one or more battery cells 504, and one or more circuit boards 506 having processors for controlling the charging or for providing an electrical connection, for data transfer and/or charging through a physical connection, such as a USB port or other connector. The charger 501 can further include a bottom enclosure 508. The charger 501 can be attached to a fluid container 500, either on a bottom, a top, or along a side of the fluid container 500.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. An apparatus for providing a fluid to a user and an electric charge to an electronic device, the apparatus comprising:
a body having an opening at a proximal end, the body forming a vessel in communication with the opening, the vessel for containing the fluid to be provided to the user via the opening;
a cap that is removably attached to the body proximate the opening to alternatively open and seal the opening; and
a battery assembly attached to the body at a distal end opposite the proximal end of the body, the battery assembly comprising a battery and one or more charging ports, the battery for storing the electric charge to be provided to the electronic device via the one or more charging ports.

2. The apparatus in accordance with claim 1, further comprising one or more battery life indicators to indicate a battery life of the battery.

3. The apparatus in accordance with claim 1, wherein the one or more battery life indicators are Light Emitting Diodes (LEDs).

4. The apparatus in accordance with claim 1, wherein the cap can be attached by corresponding thread members on each of the cap and the body.

5. The apparatus in accordance with claim 1, wherein the cap can be attached by a friction fit between the cap and the opening.

6. The apparatus in accordance with claim 1, wherein at least one of the one or more charging ports is a Universal Serial Bus (USB) port.

7. The apparatus in accordance with claim 1, wherein the battery assembly is removably attached to the body by threaded connectors.

8. The apparatus in accordance with claim 1, further comprising a power indicator on the battery assembly.

9. The apparatus in accordance with claim 8, wherein the power indicator on the battery assembly comprises one or more Light Emitting Diodes (LEDs).

10. The apparatus in accordance with claim 1, wherein the body is a double-walled body with an insulating seal.

11. The apparatus in accordance with claim 10, wherein the insulating seal is a vacuum seal.
